(19) United States
(12) Patent Application Publication
(10) Pub. No.: US 2019/0159570 A1
(43) Pub. Date: May 30, 2019

(54) STEAM-OFF GEL NAIL REMOVAL DEVICE

(71) Applicant: COSMEX CO., LTD., New Taipei City (TW)

(72) Inventors: Wan Chieh HSIEH, New Taipei City (TW); Pai Yao HSIEH, New Taipei City (TW); Hung Wei CHANG, New Taipei City (TW); Kuan Chen LIAO, New Taipei City (TW)

(21) Appl. No.: 15/859,960

(22) Filed: Jan. 2, 2018

(30) Foreign Application Priority Data
Nov. 30, 2017 (TW) 106217834

(51) Int. Cl. A45D 29/00; B08B 3/00; F22B 3/02

(52) U.S. Cl. CPC A45D 29/007; A45D 2200/155; F22B 3/02; B08B 3/00

(57) ABSTRACT

The present invention provides a steam-off gel nail removal device comprising a casing. A plurality of finger insertion holes for finger insertion is disposed on one side of the casing, and a receiving space is disposed on the inner side of the casing. The receiving space has therein a heating device and a control device connected to the heating device. A gel polish removing solution container is disposed on the inner side of the receiving space. The heating device is disposed on one side of the gel polish removing solution container to heat the gel polish removing solution container. The steam-off gel nail removal device of the present invention further comprises a safety switch and a finger separation unit for taking safety-enhancing measures to ensure user safety. The finger insertion holes are sufficient for every user's left hand or right hand to be placed comfortably on the steam-off gel nail removal device.

### BACKGROUND OF THE INVENTION

### Technical Field

The present invention relates to steam-off gel nail removal devices and, more particularly, to an ergonomic, safe steam-off gel nail removal device.

### Description of Related Art

Manicure and UV curing technology is increasingly advanced. In addition to advancements in manicure-oriented curing device-related technology, rapid development of gel nail removal device-related technology has begun. In the early development stage of the aforesaid technology, artificial gel nail removal entails placing fingers in direct contact with a gel polish removing solution; however, in doing so, a large amount of the gel polish removing solution permeates into the human skin. With the gel polish removing solution being an organic solvent, its permeation into the human skin is likely to cause hazards to human health. Furthermore, nail forceps and brushes being used in removing well-soaked gel nails are likely to scrape the nails.

The latest development stage of the aforesaid technology is accompanied by an attempt to improve the aforesaid artificial gel nail removal technique by developing a steam-off gel remover. The steam-off gel remover works by evaporating the gel polish removing solution into a steam intended to come into contact with gel nails to not only reduce the chance that a large amount of the gel polish removing solution will permeate into the human skin but also soften the gel nails gradually. A further advantage of the steam-off gel remover is that gel nail removal merely requires scraping the gel nails mildly, thereby reducing the chance that the nails will be scraped.

However, the steam-off gel remover has its drawbacks, which are described below. Users often begin operating the steam-off gel remover even though it has not yet been fully assembled; as a result, the users' inadvertent, forceful manipulation of the steam-off gel remover not only leads to disintegration thereof but also causes a gel polish removing solution container to topple. The toppling of the gel polish removing solution container not only empties inevitably the gel polish removing solution but also poses safety issues, such as increased chances of burns and electric shocks. Furthermore, insertion of a user's fingers into the steam-off gel remover increases the chance that the user's fingers will come into contact with the gel polish removing solution in the gel polish removing solution container to therefore cause burns to the fingers and permeation of the gel polish removing solution into the human skin. Apart from the aforesaid safety issues, the users must have their fingers placed in the steam-off gel remover for at least three minutes in order to soften gel nails and thus their hands have been tingling uncomfortably by the time the users withdraw their fingers.

To overcome the aforesaid drawbacks of the conventional steam-off gel remover, the inventor of the present invention made efforts to improve the conventional steam-off gel remover by developing a steam-off gel nail removal device of the present invention.

### BRIEF SUMMARY OF THE INVENTION

An objective of the present invention is to provide a steam-off gel nail removal device which ensures that operation thereof can start only when fully assembled, features a separation component whereby users' fingers are prevented from coming into contact with a gel polish removing solution, and meets ergonomic requirements such that the users' fingers can be inserted into and placed in the steam-off gel nail removal device without tingling uncomfortably.

To complete the aforementioned objective, the present invention provides a steam-off gel nail removal device, comprising a casing, a gel polish removing solution container, and a finger separation unit. A plurality of finger insertion holes for finger insertion disposed on a side of the casing and a receiving space disposed on an inner side of the casing, wherein the receiving space has therein a heating device and a control device connected to the heating device. The gel polish removing solution container is disposed on an inner side of the receiving space, wherein the heating device is disposed on a side of the gel polish removing solution container to heat the gel polish removing solution container. The finger separation unit is disposed in the receiving space and between the gel polish removing solution container and the finger insertion holes, wherein a steam passing structure for a steam of a gel polish removing solution to pass through is arranged on the finger separation unit.

Another objective of the present invention is to provide a steam-off gel nail removal device, comprising a casing and a gel polish removing solution container. At least six finger insertion holes for finger insertion disposed on a side of the casing, and a receiving space disposed on an inner side of the casing, wherein the receiving space having therein a heating device and a control device connected to the heating device. The gel polish removing solution container is disposed on an inner side of the receiving space, wherein the heating device is disposed on a side of the gel polish removing solution container to heat the gel polish removing solution container.

Furthermore, the above steam-off gel nail removal device further comprises a finger separation unit disposed between the gel polish removing solution container and the finger insertion holes, wherein a steam passing structure for a steam of a gel polish removing solution to pass through is arranged on the finger separation unit.

Another objective of the present invention is to provide a steam-off gel nail removal device, comprising a casing, a gel polish removing solution container, and a safety switch. A plurality of finger insertion holes disposed on the casing, and a receiving space disposed in the casing. The casing comprises a main casing portion and an opening and closing mechanism disposed on the main casing portion. The receiving space has therein a heating device and a control device connected to the heating device. The gel polish removing solution container is disposed on the main casing portion, and the heating device is disposed on a side of the gel polish removing solution container to heat the gel polish removing solution container. The safety switch is disposed on the main casing portion, corresponds in position to the opening and closing mechanism, and electrically connected to one of the heating device and the control device to trigger shutting down the heating device, pausing the heating device or inhibiting the heating device from starting.

Furthermore, the finger insertion holes are in a number of at least six.

Furthermore, the above steam-off gel nail removal device further comprises a finger separation unit disposed between the gel polish removing solution container and the finger insertion holes, wherein a steam passing structure for a steam of a gel polish removing solution to pass through is arranged on the finger separation unit.

Furthermore, the plurality of finger insertion holes on the casing is disposed eccentrically thereon.

Furthermore, the casing has therein a receiving bracket having thereon a receiving opening for receiving the gel polish removing solution container, with the receiving opening being disposed eccentrically on the receiving bracket and facing a side of the finger insertion holes.

Furthermore, an O-ring is disposed between the receiving bracket and the gel polish removing solution container.

Furthermore, a secondary gel polish removing solution container is disposed removably on the gel polish removing solution container and adapted to contain the gel polish removing solution.

Furthermore, the casing has thereon a preheat lid for covering the plurality of finger insertion holes.

Furthermore, at least one non-slip pad is disposed at a bottom of the casing.

Furthermore, a temperature sensor for detecting a temperature of the gel polish removing solution container is disposed beside the gel polish removing solution container to transmit the temperature of the gel polish removing solution container to the control device such that the control device adjusts a power of the heating device in accordance with the temperature thus fed back and shut down or pause the heating device upon determination that the temperature thus fed back is higher than a threshold.

Furthermore, an elastic airtight unit is disposed on or beside the finger insertion holes.

Furthermore, the control device comprises a control panel, an operation interface connected to or integrated into the control panel, and a power module connected to or integrated into the control panel.

Furthermore, the operation interface is one of a buzzer, a speaker, an indicator light, a display unit, a touch panel, a touchscreen and a control knob.

Furthermore, the power module is one of a power bank, a battery and an external power supply.

Furthermore, the control device has a timer for recording a predetermined heating time of the heating device and sending control signal according to the predetermined heating time.

As above, comparing to the conventional technique, the present invention has the following advantages:

1. The steam-off gel nail removal device of the present invention has therein a finger separation unit which serves as a separation component for separating a gel polish removing solution container from the user's fingers to therefore prevent the user's fingers from coming into contact with a gel polish removing solution in the gel polish removing solution container, protect the users' fingers against burns, and prevent permeation of the gel polish removing solution into the human skin.

2. The steam-off gel nail removal device of the present invention comprises a safety switch which ensures that the steam-off gel nail removal device can be started to operate only when fully assembled, and thus even the user's forceful manipulation of the steam-off gel nail removal device is unlikely to cause disintegration of the steam-off gel nail removal device, empty the gel polish removing solution, and pose safety issues, such as increased chances of burns and electric shocks.

3. The steam-off gel nail removal device of the present invention comprises six finger insertion holes and a receiving opening of a receiving bracket which are eccentrically positioned to meet ergonomic structural requirements such that the user's hands do not tingle uncomfortably when placed on the steam-off gel nail removal device.

### BRIEF DESCRIPTION OF THE SEVERAL VIEWS OF THE DRAWINGS

FIG. 1 is a perspective view of a steam-off gel nail removal device of the present invention;

FIG. 2 is a lateral cross-sectional view (1) of the steam-off gel nail removal device of the present invention;

FIG. 3 is a lateral cross-sectional view (2) of the steam-off gel nail removal device of the present invention;

FIG. 4 is a cross-sectional view of the steam-off gel nail removal device of the present invention;

FIG. 5 is a lateral view (1) of a safety switch of the steam-off gel nail removal device of the present invention; and

FIG. 6 is a lateral view (2) of the safety switch of the steam-off gel nail removal device of the present invention.

### DETAILED DESCRIPTION OF THE EMBODIMENT OF THE INVENTION

The details and technical solution of the present invention are hereunder described with reference to accompanying drawings. For illustrative sake, the accompanying drawings are not drawn to scale. The accompanying drawings and the scale thereof are not restrictive of the present invention.

The terms “comprise” and “include” used herein means the component, process steps, operating steps and/or element of the present invention do not exclude to have one or more than one of other component, process steps, operating steps and/or element. The term “one” used herein means the object phrase is one or more than one (at least one).

The detailed description and the preferred embodiment of the present invention are as followed below; however, it should be noted that these preferred embodiment are for helping to understand the present invention more clearly instead of limiting the scope of the present invention.

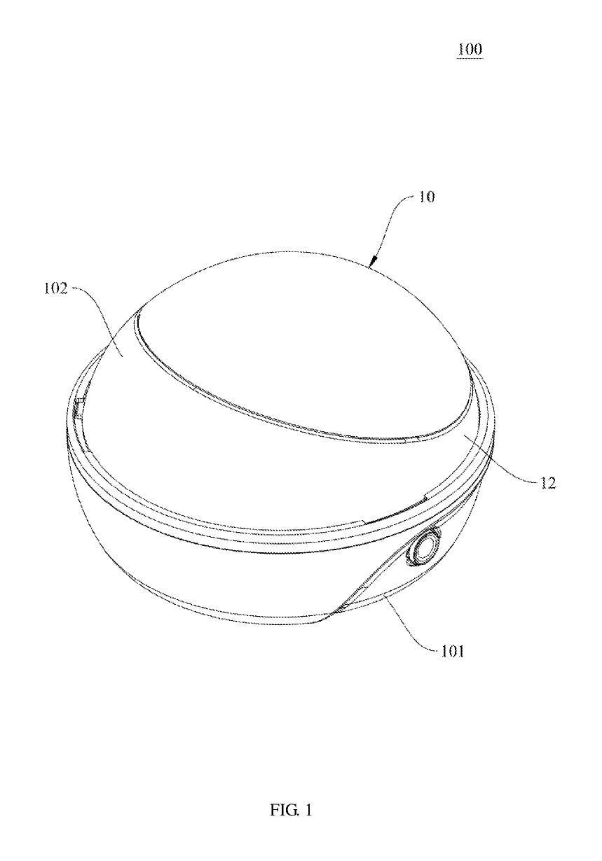

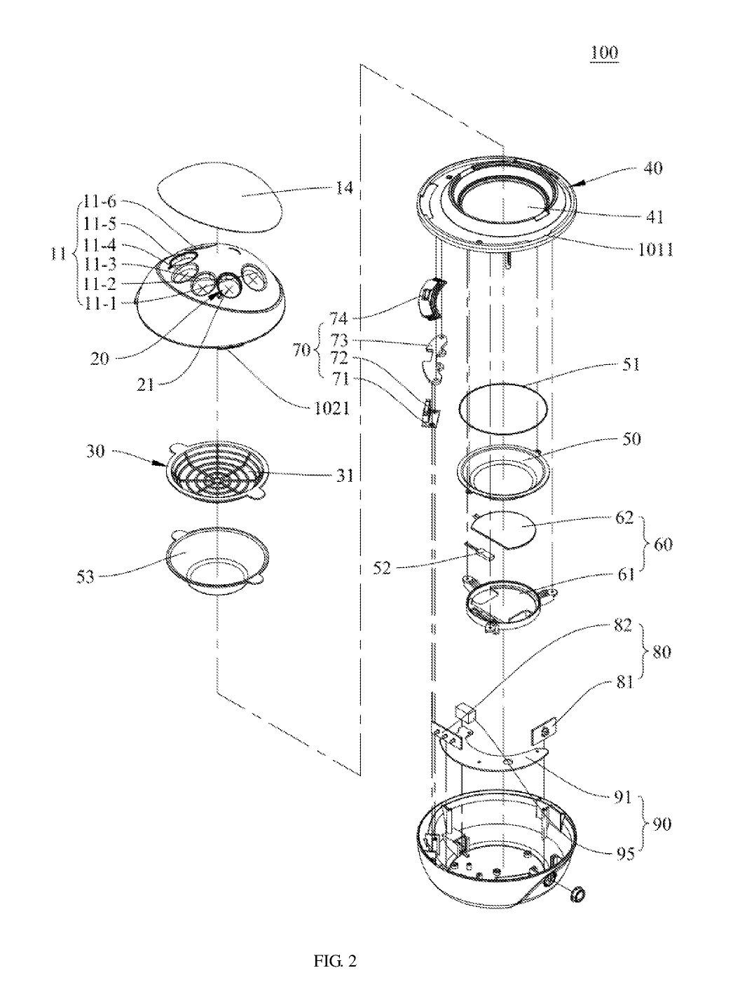

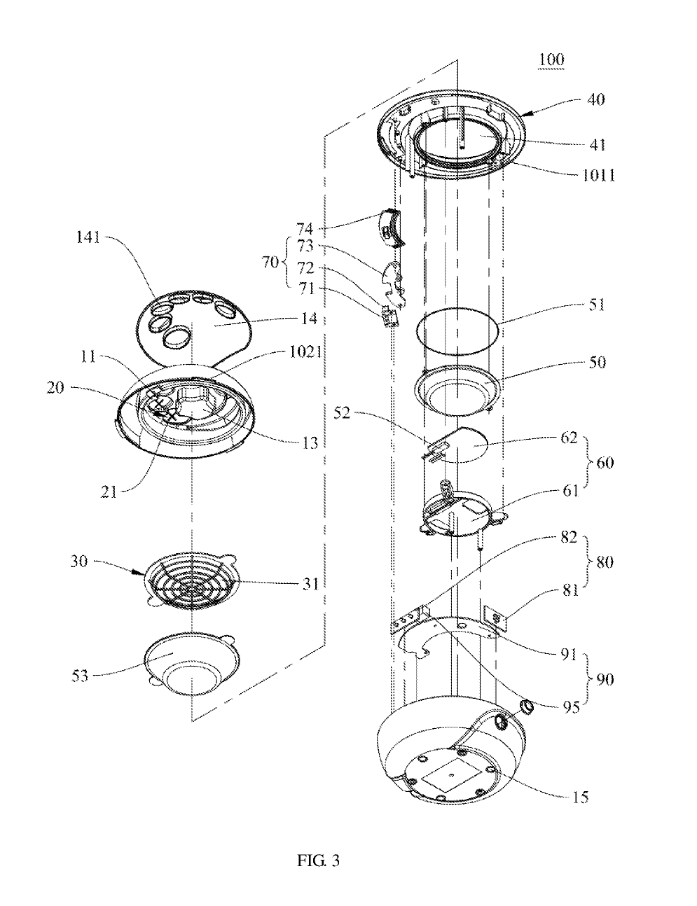

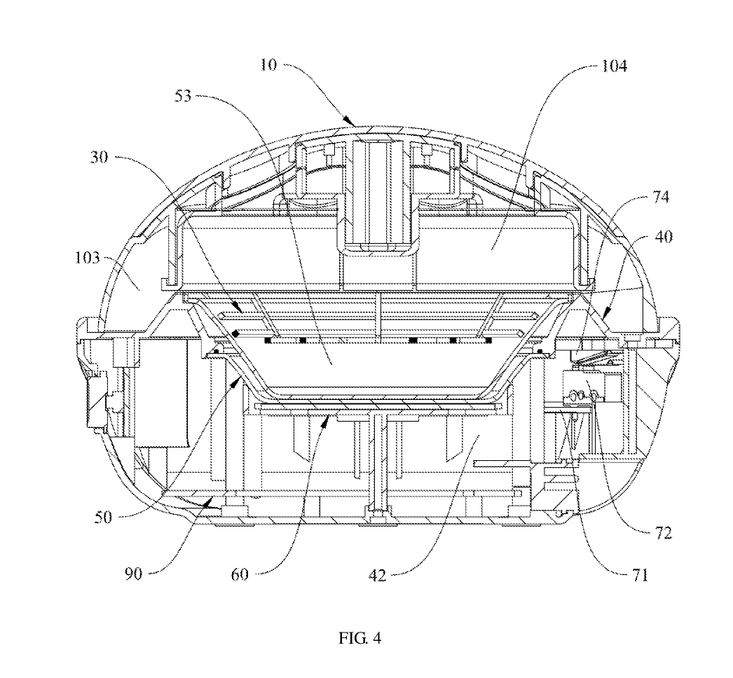

Referring to FIG. 1, FIG. 2, FIG. 3 and FIG. 4, there are shown a perspective view, a lateral cross-sectional view (1), a lateral cross-sectional view (2) and a cross-sectional view of a steam-off gel nail removal device of the present invention.

A steam-off gel nail removal device 100 of the present invention essentially comprises a casing 10. The casing 10 is mainly divided into two parts, namely a main casing portion 101 and an opening and closing mechanism 102 disposed on the main casing portion 101. The inner side of the casing 10 has a receiving space 103. The receiving space 103 has therein an elastic airtight unit 20, a finger separation unit 30, a receiving bracket 40, a gel polish removing solution container 50, a heating device 60, a safety switch 70, an operation interface 80, and a control device 90. One side of the casing 10 has a plurality of finger insertion holes 11 which a user's fingers can be inserted into, respectively. The receiving bracket 40 is disposed on the inner side of the casing 10 and adapted to hold the gel polish removing solution container 50. The heating device 60 heats a gel polish removing solution in the gel polish removing solution container 50 to form a steam chamber 104 within the space above the gel polish removing solution container 50. After penetrating the finger insertion holes 11, the user's fingers enter the steam chamber 104 such that the vaporized gel polish removing solution is uniformly adsorbed on the user's nails to remove gel nails.

From an anatomical perspective on the human hand, not only is the thumb spaced apart from the other four fingers by a large distance, but the left and right hands are also mirror images of each other. To render the steam-off gel nail removal device 100 ergonomic, the steam-off gel nail removal device 100 has six finger insertion holes 11, which are, from right to left, the finger insertion hole 11-1, the finger insertion hole 11-2, the finger insertion hole 11-3, the finger insertion hole 11-4, the finger insertion hole 11-5, and the finger insertion hole 11-6. The thumb and four other fingers of the right hand are inserted into the finger insertion hole 11-1, the finger insertion hole 11-3, the finger insertion hole 11-4, the finger insertion hole 11-5, and the finger insertion hole 11-6, respectively, such that the thumb and the index finger of the right hand are separated by the finger insertion hole 11-2. By contrast, the thumb and four other fingers of the left hand are inserted into the finger insertion hole 11-6, the finger insertion hole 11-4, the finger insertion hole 11-3, the finger insertion hole 11-2, and the finger insertion hole 11-1, respectively, such that the thumb and the index finger of the left hand are separated by the finger insertion hole 11-5. Hence, the steam-off gel nail removal device 100 is ergonomic and comfortable to the user, regardless whether she/he puts the left hand or the right hand on the steam-off gel nail removal device 100. In another preferred embodiment, a steam-off gel nail removal device with more than six finger insertion holes 11 can also achieve the aforesaid effect; hence, the steam-off gel nail removal device with more than six finger insertion holes 11 falls within the scope of the present invention as well.

Similarly, to dispense with the need to bend the wrist (which causes discomfort) in order to insert the fingers into the finger insertion holes 11, the plurality of finger insertion holes 11 is disposed eccentrically on the casing 10. After the user's fingers have been inserted into the finger insertion holes 11, the user's palm rests on the casing 10, whereas the user's wrist or forearm rests on a desktop, a platform, or a cushion, so as to lessen the hand's burden. A receiving opening 41 of the receiving bracket 40 in the casing 10 is disposed eccentrically on the receiving bracket 40 so as to correspond in position to the finger insertion holes 11. With the gel polish removing solution container 50 being positioned at the receiving opening 41, the upward opening of the gel polish removing solution container 50 corresponds substantially in position to the plurality of finger insertion holes 11. To allow the user to clean the gel polish removing solution container 50, a secondary gel polish removing solution container 53 is disposed removably above the gel polish removing solution container 50 and adapted to contain the gel polish removing solution.

A grip unit 13 is disposed on the inner side of the casing 10 and corresponds in position to the center of the plurality of finger insertion holes 11. After passing his or her fingers through the plurality of finger insertion holes 11, respectively, the user can easily grip the grip unit 13 and thus use it as a support for his or her fingers, so as to lessen the fingers' burden. After the user's fingers have gripped the grip unit 13, the nails of the fingers face downward spontaneously and thereby point at the top of the gel polish removing solution container 50. In a preferred embodiment, the user's fingers rest directly on the finger separation unit 30 to enhance the efficiency of gel nail removal.

A preheat lid 14 for covering the six finger insertion holes 11 is disposed on the casing 10. A protruding portion 141 protrudes from below the preheat lid 14 and corresponds in position to the six finger insertion holes. The protruding portion 141 is coupled to the six finger insertion holes 11 from above to therefore achieve airtightness. The preheat lid 14 covers the finger insertion holes 11 while the steam-off gel nail removal device 100 of the present invention is in operation to not only preheat the gel polish removing solution to an evaporation temperature thereof but also increase the concentration of the gel polish removing solution's steam in the steam chamber 104 with a view to enhancing the efficiency of gel nail removal.

To prevent the steam in the steam chamber 104 from spreading to the air in the surroundings, one side of the finger insertion holes 11 has an elastic airtight unit 20. After the user's fingers have been withdrawn from the finger insertion holes 11, a gasket disposed on the elastic airtight unit 20 seals the finger insertion holes 11. After the user's fingers have been inserted into the finger insertion holes 11, the elastic airtight unit 20 encloses the fingers tightly such that the steam-off gel nail removal device 100 in operation is airtight. In a preferred embodiment, the elastic airtight unit 20 is changeable. The elastic airtight unit 20 is in contact with the user's fingers. Since different users can use the steam-off gel nail removal device 100, the elastic airtight unit 20 which is changeable also serves a hygienic purpose. In this preferred embodiment, the elastic airtight unit 20 is a soft gasket. Slit holes 21 are formed, for example, by a cutting process, on the soft gasket in such a manner that the slit holes 21 correspond in position to the finger insertion holes. A clamping unit is disposed at the bottom of the soft gasket and coupled to the inner side of the casing 10 so as to fix the soft gasket in place between the clamping unit and the casing 10. In this preferred embodiment, the slit holes 21 are cruciform. The slit holes 21 may take on any other shapes to meet product requirements or may be an elastic, contractile hole capable of memorization, as the present invention is not limited thereto. In addition to this embodiment, the elastic airtight unit 20 is fixed to the inner side of the casing 10 by any other means (for example, adhesive bonding), or is replaced by an elastic seal case disposed on the casing 10, wherein the seal case is cut to form finger insertion holes thereon. Alternatively, a plurality of soft gaskets is each fixed to the inner side of the finger insertion holes 11, as the present invention is not limited thereto. In a preferred embodiment, to prevent the casing 10 from sliding, one or more non-slip pads 15 are disposed at the bottom of the casing 10 to increase friction between the casing 10 and the desktop.

In this preferred embodiment, the opening and closing mechanism 102 is a rotate-to-fasten cover disposed on the main casing portion 101. A lock point mechanism 1021 is disposed on the rotate-to-fasten cover. The rotate-to-fasten cover is fixed in place as soon as the lock point mechanism 1021 is engaged with the opening of the main casing portion 101 and turned laterally to the inner side of a limiting latch 1011. Demounting the rotate-to-fasten cover merely requires the user to exert a force to rotate the rotate-to-fasten cover and thus separate the lock point mechanism 1021 from the inner side of the limiting latch 1011, so as to remove the rotate-to-fasten cover and replenish the gel polish removing solution container 50 in the casing 10. In another preferred embodiment, the opening and closing mechanism 102 is any structure, such as a flip cover, an elastic lid, a spiral cover or the like, which opens and closes relative to the main casing portion 101, so as to form an open-style opening whereby the user replenishes the gel polish removing solution, as the present invention is not limited thereto.

To protect the user against burns caused by a heating device while the user is replenishing the gel polish removing solution or cleaning the gel polish removing solution container, the safety switch 70 is disposed on the main casing portion 101 and corresponds in position to the opening and closing mechanism 102. The safety switch 70 is electrically connected to the control device 90 to trigger shutting down or pausing the heating device 60. In addition to controlling the switching of the heating device 60 by the control device 90, in another preferred embodiment the safety switch 70 is directly disposed at the front ends of the heating device 60 and the control device 90 to ensure that the heating device 60 is in an open-circuit state while the opening and closing mechanism 102 is ON.

In this preferred embodiment, the receiving bracket 40 is mounted on the main casing portion 101 and forms an internal chamber 42. The heating device 60 and the control device 90 are disposed in the internal chamber 42. The receiving bracket 40 and the main casing portion 101 are fixed to the main casing portion 101 by screwing, engagement, thermal sealing, adhesive bonding or in any other manner, as the present invention is not limited thereto. High-precision electronic circuit devices are disposed in the internal chamber 42. To protect the electronic circuit devices in the internal chamber 42, an O-ring 51 is disposed between the receiving bracket 40 and the gel polish removing solution container 50. The O-ring 51 is disposed at the peripheries of the gel polish removing solution container 50 to allow the receiving bracket 40 and the gel polish removing solution container 50 to be coupled together tightly to therefore block the passage of any gas or liquid and prevent the steam of the gel polish removing solution from entering the internal chamber 42 of the main casing portion 101 through any gap between related components to cause damage to the heating device 60 and the control device 90 (such as rusting or oxidation) and prevent the emptying of the gel polish removing solution into the internal chamber 42 when the steam-off gel nail removal device 100 topples to cause damage to the heating device 60 and the control device 90.

To prevent the user's fingers from inadvertently coming into contact with the gel polish removing solution in the gel polish removing solution container to cause burns to the fingers or protect the user against allergy which might happen to the user because of the irritative contact between the human skin and the gel polish removing solution, the finger separation unit 30 is disposed between the gel polish removing solution container 50 and the finger insertion holes 11 in the steam chamber 104 to conceal the gel polish removing solution container 50 from above so as to protect the user's fingers. A steam passing structure 31 which a steam of the gel polish removing solution passes through is arranged on the finger separation unit 30 such that the steam which has passed through the steam passing structure 31 rises and spreads without hindrance. In this preferred embodiment, the finger separation unit 30 is a separation net, whereas the steam passing structure 31 is a grating structure arranged on the separation net. The grating structure is of any shape as needed, as the present invention is not limited thereto. In another preferred embodiment, the finger separation unit 30 is a separation gate, a single-holed board, a multi-holed board or the like with a low coefficient of thermal conductivity to prevent the fingers from coming into contact with the gel polish removing solution container 50, without affecting the passage of the steam, as the present invention is not limited thereto.

The heating device 60 is disposed below the gel polish removing solution container 50. The heating device 60 comprises a heating bracket 61 and a heating pad 62. The heating pad 62 is disposed on the heating bracket 61. During the operation of the steam-off gel nail removal device 100, the gel polish removing solution container 50 is disposed in the receiving opening 41 and thus in contact with the heating pad 62 for heating such that the gel polish removing solution in the gel polish removing solution container 50 is heated and evaporated. To control the temperature of the gel polish removing solution container 50, a temperature sensor 52 for detecting the temperature of the gel polish removing solution container 50 is disposed on one side of the gel polish removing solution container 50. The temperature sensor 52 transmits the temperature of the gel polish removing solution container 50 to the control device 90. The control device 90 adjusts the power of the heating device 60 in accordance with the temperature thus fed back and shuts down or pauses the heating device 60 upon determination that the temperature thus fed back is higher than a threshold.

To supply required power to the steam-off gel nail removal device 100, the steam-off gel nail removal device 100 further comprises a power module 95. The power module 95 is connected to an external power supply of grid power, a power supply adapter, a built-in battery of the steam-off gel nail removal device 100, or a power bank disposed demountably on the steam-off gel nail removal device 100, as the present invention is not limited thereto. In this preferred embodiment, the power module 95 further comprises, for example, a transformer, a rectifier, a wave filter, a surge protection circuit, or any equivalent circuit, for performing front-end processing on a power supply. In a preferred embodiment, the aforesaid front-end circuit of the power module 95 functions as an external transformer which is disposed outside the steam-off gel nail removal device 100 to reduce weight and volume of the steam-off gel nail removal device 100 or is directly integrated into a circuit board and disposed on the inner side of the steam-off gel nail removal device 100, as the present invention is not limited thereto.

The control device 90 comprises a control panel 91. A controller, a related circuit and electronic parts and components are disposed on the control panel 91 to form a controller loop. In an embodiment, the operation interface 80 and the power module 95 are mounted on and integrated into the control panel 91 and are electrically connected to the controller. In another preferred embodiment, electronic parts and components or devices with specific functions, which are disposed on the control device 90, can be mounted on a plurality of circuit boards and connected to connectors or wirings, as the present invention is not limited thereto. With the operation interface 80, the user selects or enters operating modes of parameters for regulating, for example, temperature and time. In a preferred embodiment, the operation interface 80 comprises a control knob 81 and an indicator light 82. The control knob 81 functions as a human-machine interface which a command is entered into and thus sent to the controller. The indicator light 82 sends the status of a device for the user to confirm. In another preferred embodiment, the operation interface 80 is a speaker, buzzer, display unit, touch panel, touchscreen, or any equivalent of a human-machine interface, as the present invention is not limited thereto. An opening is disposed on the casing 10 and corresponds in position to the operation interface 80 such that the operation interface 80 is exposed from the opening of the casing 10 for the user to operate. In another preferred embodiment, the casing 10 is made of a transparent material, a partially transparent material, or a translucent material such that the operation interface 80 in the casing 10 is visible to users, not to mention that the casing 10 functions as an insulating layer for a touch panel to facilitate operation thereof, as the present invention is not limited thereto.

In a preferred embodiment, the control device 90 has a timer for recording a predetermined heating time of the heating device 90 and sending a control signal according to the predetermined heating time. The steam-off gel nail removal device 100 of the present invention uses the operation interface 80 to configure the heating time of the heating device 60, and the user configures time as needed. Alternatively, the steam-off gel nail removal device 100 directly preconfigures at least one heating time. After detecting the heating time, the timer sends a control signal for shutting down or pausing the heating device 60.

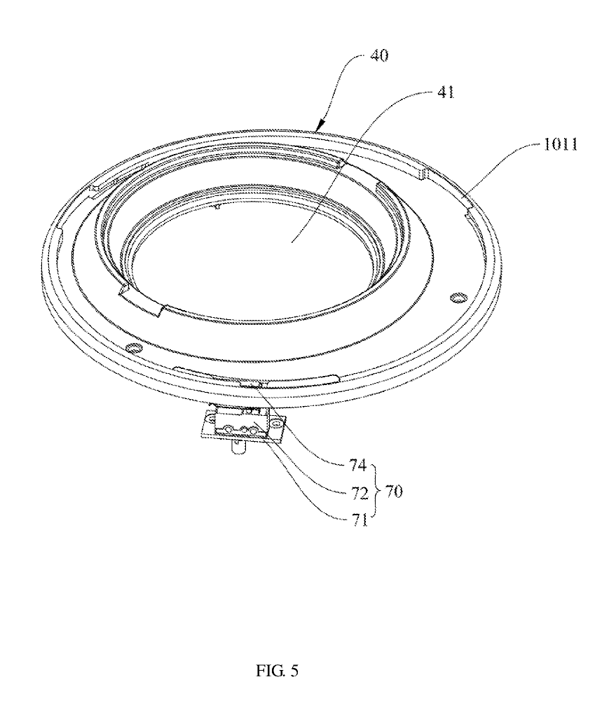

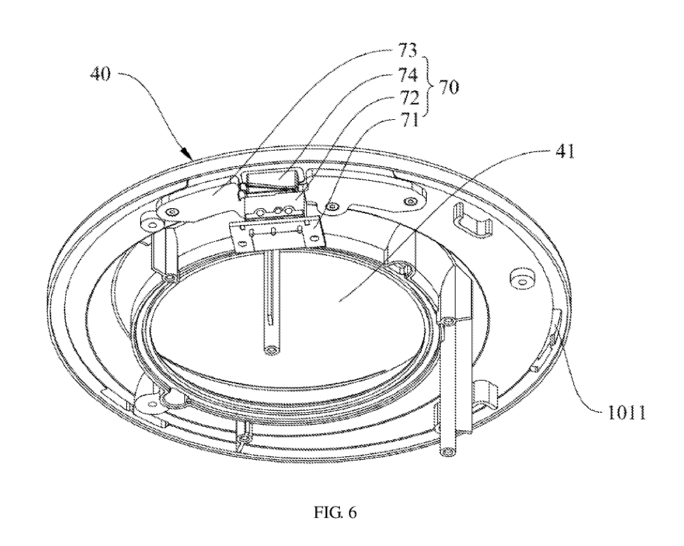

Referring to FIG. 5 and FIG. 6, in a preferred embodiment, the safety switch 70 is a microswitch. The microswitch is disposed on one side of the receiving bracket 40. As soon as the rotate-to-fasten cover covers the receiving bracket 40 and turns the lock point mechanism 1021 to the limiting latch 1011, a bump (not shown) disposed on an inner side of the rotate-to-fasten cover presses against the microswitch from above to trigger a first state (for example, signal 1) of the microswitch. As soon as the rotate-to-fasten cover separates from the receiving bracket 40, a second state (for example, signal 0) of the microswitch is triggered. Hence, receipt of signal 0 from the microswitch by the control device 90 triggers shutting down (for example, by directly creating an open circuit in or interrupting the power supply to) the heating device 60, pausing (for example, by triggering a standby mode or a hibernation mode of) the heating device 60 or inhibiting (for example, by inhibiting the start of) the heating device 60 from starting.

Fine structures of the microswitch are described as follows: the microswitch essentially comprises a circuit board 71, a microswitch body 72 disposed on the circuit board 71, a top board 74 disposed on the microswitch body 72, and a top board bracket 73 for supporting the top board 74. An engagement-protrusion point is disposed on the top board 74 and corresponds in position to the limiting latch 1011 to operate in conjunction with the bump on the inner side of the rotate-to-fasten cover. A guide bump is disposed at the bottom of the top board 74. The top board bracket 73 fixes the two ends of the top board 74 in place and has a centrally-located slot of an appropriate size for passage of the guide bump at the bottom of the top board 74. The guide bump moves resiliently along the slot. The inner side of the microswitch body 72 has a press sensor. As soon as the top board 74 is touched and moved downward, it comes into contact with a leaf spring on the microswitch to therefore turn on or create an open circuit in the press sensor (that is, generally by “touch and turn on,” but the present invention does not rule out “touch and create an open circuit”), thereby triggering the microswitch to generate a triggering signal.

As soon as the rotate-to-fasten cover is rotated and tightened, the top board 74 presses against the microswitch body 72; meanwhile, the microswitch body 72 transmits a first triggering signal to the control device 90. After receiving the first triggering signal, the control device 90 disables the locking of the heating device 60. Hence, it is only when the top board 74 presses against the microswitch body 72 that the steam-off gel nail removal device 100 starts to operate. The microswitch has a protection circuit for ensuring user safety during operation and protecting users against safety risks, such as burns and electric shocks, arising from the users' inadvertent touch on the steam-off gel nail removal device 100. In another preferred embodiment, the safety switch 70 is a leaf-spring switch or a spring switch, as the present invention is not limited thereto.

Therefore, a steam-off gel nail removal device of the present invention has therein a finger separation unit which serves as a separation component for separating a gel polish removing solution container from the user's fingers to therefore prevent the user's fingers from coming into contact with a gel polish removing solution in the gel polish removing solution container, protect the users' fingers against burns, and prevent permeation of the gel polish removing solution into the human skin. The steam-off gel nail removal device of the present invention ensures that the steam-off gel nail removal device can be started to operate only when fully assembled, and thus even the user's forceful manipulation of the steam-off gel nail removal device is unlikely to cause disintegration of the steam-off gel nail removal device, empty the gel polish removing solution, and pose safety issues, such as increased chances of burns and electric shocks. The steam-off gel nail removal device of the present invention meets ergonomic requirements such that the users' fingers can be inserted into and placed in the steam-off gel nail removal device without tingling uncomfortably.

The above is the detailed description of the present invention. However, the above is merely the preferred embodiment of the present invention and cannot be the limitation to the implement scope of the present invention, which means the variation and modification according the present invention may still fall into the scope of the invention.

What is claimed is:

1. A steam-off gel nail removal device, comprising:
a casing, wherein a plurality of finger insertion holes for finger insertion is disposed on a side of the casing, and a receiving space is disposed on an inner side of the casing, the receiving space having therein a heating device and a control device connected to the heating device;
a gel polish removing solution container disposed on an inner side of the receiving space, wherein the heating device is disposed on a side of the gel polish removing solution container to heat the gel polish removing solution container; and
a finger separation unit disposed in the receiving space and between the gel polish removing solution container and the finger insertion holes, wherein a steam passing structure for a steam of a gel polish removing solution to pass through is arranged on the finger separation unit.

2. The steam-off gel nail removal device of claim 1, wherein the plurality of finger insertion holes on the casing is disposed eccentrically thereon.

3. The steam-off gel nail removal device of claim 2, wherein the casing has therein a receiving bracket having thereon a receiving opening for receiving the gel polish removing solution container, with the receiving opening being disposed eccentrically on the receiving bracket and facing a side of the finger insertion holes.

4. The steam-off gel nail removal device of claim 1, wherein an O-ring is disposed between the receiving bracket and the gel polish removing solution container.

5. The steam-off gel nail removal device of claim 1, wherein a secondary gel polish removing solution container is disposed removably on the gel polish removing solution container and adapted to contain the gel polish removing solution.

6. The steam-off gel nail removal device of claim 1, wherein the casing has thereon a preheat lid for covering the plurality of finger insertion holes.

7. The steam-off gel nail removal device of claim 1, wherein at least one non-slip pad is disposed at a bottom of the casing.

8. The steam-off gel nail removal device of claim 1, wherein a temperature sensor for detecting a temperature of the gel polish removing solution container is disposed beside the gel polish removing solution container to transmit the temperature of the gel polish removing solution container to the control device such that the control device adjusts a power of the heating device in accordance with the temperature thus fed back or shut down or pause the heating device upon determination that the temperature thus fed back is higher than a threshold.

9. The steam-off gel nail removal device of claim 1, wherein an elastic airtight unit is disposed on or beside the finger insertion holes.

10. The steam-off gel nail removal device of claim 1, wherein the control device comprises a control panel, an operation interface connected to or integrated into the control panel, and a power module connected to or integrated into the control panel.

11. The steam-off gel nail removal device of claim 10, wherein the operation interface is a buzzer, a speaker, an indicator light, a display unit, a touch panel, a touchscreen or a control knob.

12. The steam-off gel nail removal device of claim 10, wherein the power module is a power bank, a battery or an external power supply.

13. The steam-off gel nail removal device of claim 10, wherein the control device has a timer.

14. A steam-off gel nail removal device, comprising:
a casing, wherein at least six finger insertion holes for finger insertion are disposed on a side of the casing, and a receiving space is disposed on an inner side of the casing, the receiving space having therein a heating device and a control device connected to the heating device; and
a gel polish removing solution container disposed on an inner side of the receiving space, wherein the heating device is disposed on a side of the gel polish removing solution container to heat the gel polish removing solution container.

15. The steam-off gel nail removal device of claim 14, further comprising: a finger separation unit disposed in the receiving space and between the gel polish removing solution container and the finger insertion holes; and a steam passing structure adapted for a steam of a gel polish removing solution to pass through and arranged on the finger separation unit.

16. The steam-off gel nail removal device of claim 14, wherein the finger insertion holes on the casing is disposed eccentrically thereon.

17. A steam-off gel nail removal device, comprising:
a casing, wherein a plurality of finger insertion holes is disposed on the casing, and a receiving space is disposed in the casing, the casing comprising a main casing portion and an opening and closing mechanism disposed on the main casing portion, and the receiving space having therein a heating device and a control device connected to the heating device;
a gel polish removing solution container is disposed on the main casing portion, and the heating device is disposed on a side of the gel polish removing solution container to heat the gel polish removing solution container; and
a safety switch disposed on the main casing portion, corresponding in position to the opening and closing mechanism, and electrically connected to one of the heating device and the control device to trigger shutting down the heating device, pausing the heating device or inhibiting the heating device from starting.

18. The steam-off gel nail removal device of claim 17, wherein the finger insertion holes are in a number of at least six.

19. The steam-off gel nail removal device of claim 17, further comprising a finger separation unit disposed between the gel polish removing solution container and the finger insertion holes, wherein a steam passing structure for a steam of a gel polish removing solution to pass through is arranged on the finger separation unit.

20. The steam-off gel nail removal device of claim 17, wherein the finger insertion holes on the casing is disposed eccentrically thereon.
